(19) United States
(12) Patent Application Publication
(10) Pub. No.: US 2020/0288914 A1
(43) Pub. Date: Sep. 17, 2020

(54) KITCHEN UTENSIL FOR REMOVING EGG CHALAZA OR EGGSHELL PIECES, AND RELATED METHODS

(71) Applicant: Jeffrey S. Paches, Edmonton (CA)

(72) Inventor: Jeffrey S. Paches, Edmonton (CA)

(21) Appl. No.: 16/820,654

(22) Filed: Mar. 16, 2020

(30) Foreign Application Priority Data
Mar. 14, 2019 (CA) 3,036,730

(51) Int. Cl. A47J 43/14; A47J 43/28

(52) U.S. Cl. CPC A47J 43/14; A47J 43/283

(57) ABSTRACT

A kitchen utensil has jaws connected to pivot relative to one another between an egg-part-receiving open position and an egg-part-holding closed position, such that teeth defined at respective grasping ends of each jaw converge upon closure to mesh and define an enclosed egg-part-holding cavity when the jaws are in the egg-part-holding closed position. A method includes converging respective grasping ends of jaws of a kitchen utensil together to close and grasp an egg chalaza or eggshell piece, adjacent to or forming part of an egg, and to retain the egg chalaza or eggshell piece within an enclosed egg-part-holding cavity that is defined between the respective grasping ends when the jaws are closed.

### TECHNICAL FIELD

This document relates to kitchen utensils and related methods of use, for example for removing egg chalaza/eggshell pieces during cooking.

### BACKGROUND

The chalaza (plural=chalazas or chalazae) is a part of the interior contents of a chicken egg. Various chalaza removing tools are known, including tweezer devices.

### SUMMARY

Kitchen utensils are disclosed for grasping and piercing items, for example egg parts.

A kitchen utensil is disclosed comprising jaws connected to pivot relative to one another between an egg-part-receiving open position and an egg-part-holding closed position, such that teeth defined at respective grasping ends of each jaw converge upon closure to mesh and define an enclosed egg-part-holding cavity when the jaws are in the egg-part-holding closed position.

A method is disclosed comprising converging respective grasping ends of jaws of a kitchen utensil together to close and grasp an egg chalaza or eggshell piece, adjacent to or forming part of an egg, and to retain the egg chalaza or eggshell piece within an enclosed egg-part-holding cavity that is defined between the respective grasping ends when the jaws are closed.

In various embodiments, there may be included any one or more of the following features: The teeth protrude outwardly relative to the egg-part-holding-cavity when the jaws are in the egg-part-holding closed position. The kitchen utensil formed as a pair of pliers. The kitchen utensil is structured such that the egg-part-holding cavity is enclosed when the jaws are in the egg-part-holding closed position. The teeth are positioned at each respective grasping end to mesh together at a front, sides, and a rear, of a jaw-to-jaw interface defined around the egg-part-holding cavity when the jaws are in the egg-part-holding closed position. The teeth are distributed to mesh continuously about the jaw-to-jaw interface to substantially encircle the egg-part-holding cavity. A first jaw of the jaws defines a first cupping member at the respective grasping end, in which the first cupping member at least partially defines the egg-part-holding cavity when the jaws are in the egg-part-holding closed position. A second jaw of the jaws defines a second cupping member at the respective grasping end, in which the first cupping member and the second cupping member collectively define the egg-part-holding cavity when the jaws are in the egg-part-holding closed position. The teeth are pointed. The teeth are triangular in shape. The jaws are biased into the egg-part-receiving open position. A torsion spring is mounted between the jaws to bias the jaws into the egg-part-receiving open position. An egg chalaza or eggshell piece is held securely within the egg-part-holding cavity. The egg chalaza or eggshell piece is grasped by teeth defined at the respective grasping ends of each jaw. The teeth are configured to mesh and define the enclosed egg-part-holding cavity when the jaws are closed. The teeth mesh together and grasp the egg chalaza or eggshell piece at sides of a jaw-to-jaw interface defined around the enclosed egg-part-holding cavity when the jaws are closed, in which the sides are defined relative to a front of the jaw-to-jaw interface adjacent the respective grasping ends. The teeth mesh together and grasp the egg chalaza or eggshell piece at or near a rear of a jaw-to-jaw interface, which is defined around the enclosed egg-part-holding cavity when the jaws are closed, in which the rear is defined relative to a front of the jaw-to-jaw interface adjacent the respective grasping ends. The enclosed egg-part-holding cavity is defined by respective cupping members at the respective grasping ends of the jaws. Opening the jaws to release the egg chalaza or eggshell piece from the enclosed egg-part-holding cavity.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a side elevation view of a kitchen utensil in an egg-part-receiving open position, with the outline of an internally mounted torsion spring shown in dashed lines.

FIG. 2 is a side elevation view of the kitchen utensil of FIG. 1 in an egg-part-holding closed position adjacent a raw egg while using teeth at a front of respective grasping ends of the jaws to grasp and retain the chalaza of the egg.

FIG. 3 is a front elevation view of the kitchen utensil of FIG. 1 in an egg-part-holding closed position while using teeth at a side of respective grasping ends of the jaws to grasp and retain the chalaza of the egg.

FIG. 4 is front elevation view of the kitchen utensil of FIG. 1 in the egg-part-receiving open position, depositing a chalaza and eggshell piece for disposal.

FIG. 5 is a top plan view of the kitchen utensil of FIG. 1.

FIG. 6 is a side elevation view of another embodiment of a kitchen utensil structured to remove a chalaza or eggshell piece.

FIG. 7 is a side elevation view of another embodiment of a kitchen utensil structured to remove a chalaza or eggshell piece.

FIGS. 8-10 are front end, side, and perspective views, respectively, of a further embodiment of a kitchen utensil, with circular cups.

FIGS. 11-14 are various views of parts of a further embodiment of a kitchen utensil, with a diamond or rectangular box shaped cups. FIG. 11 is a perspective view of one of the jaws of the utensil. FIG. 12 is a top plan view of a blank of metal cut to shape and used to form the jaw of FIG. 11, with bend lines indicated in dashed lines. FIG. 13 is a top plan view of a kitchen utensil incorporating the jaws of FIG. 11. FIG. 14 is a perspective view of the jaws of the kitchen utensil in a closed position.

### DETAILED DESCRIPTION

Immaterial modifications may be made to the embodiments described here without departing from what is covered by the claims.

Chicken eggs are widely used in many types of dishes, both sweet and savory, including baked goods. Some of the most common preparation methods include scrambling, frying, poaching, hard-boiling, soft-boiling, pickling, and making omelettes. Eggs are also in some cases eaten raw, although the cooking process may be desirable from a nutritional standpoint as cooking an egg increases the absorbability and bioavailability of the protein in the egg. As a cooking ingredient, egg yolks are an important emulsifier in the kitchen, and are also used as a thickener, for example in custards. The albumen, or egg white, contains protein, but little or no fat, and may be used in cooking with or separately from the yolk. The protein in egg whites allow the egg white to be foamed. Egg whites may be aerated or whipped to a light, fluffy consistency, for example as used to create desserts such as meringues and mousses.

A chalaza 50 is a rope-like structure that is found in the eggs of most birds and reptiles. A chalaza 50, for example a cooperating pair of chalazas 50, are proteinaceous strands or strings that serve to suspend the yolk 54 within an unopened egg, to prevent the yolk 54 from pressing against the inner walls of the eggshell. An egg may have two chalazas 50 situated on opposing sides of the yolk 54, which tether the yolk 54 to opposite ends of the eggshell. When cracking an egg, the chalazas 50 will typically remain bound to either sides of the yolk 54 of the egg. Some people may find it desirable to remove the chalazas 50 before cooking, baking, or otherwise preparing eggs as food, for example where a uniform texture is desired that may otherwise be distastefully affected by the fibrous texture of the chalaza 50. It may also be desirable to remove the chalazas 50 for aesthetic reasons—to improve the appearance of the egg.

Various devices have been designed to remove chalaza from raw, opened eggs. It has been suggested to remove the chalaza 50 using a fork or chopsticks, however such methods are generally ineffective at grasping and retaining the chalazas, and may cause the yolk to rupture. For example, chopsticks are known to have been modified for chalaza removal, by incorporating a hooking portion to grasp the chalaza. In addition, tweezers are known to have been modified for chalaza removal, for example by using projections at the front tip of the tweezers.

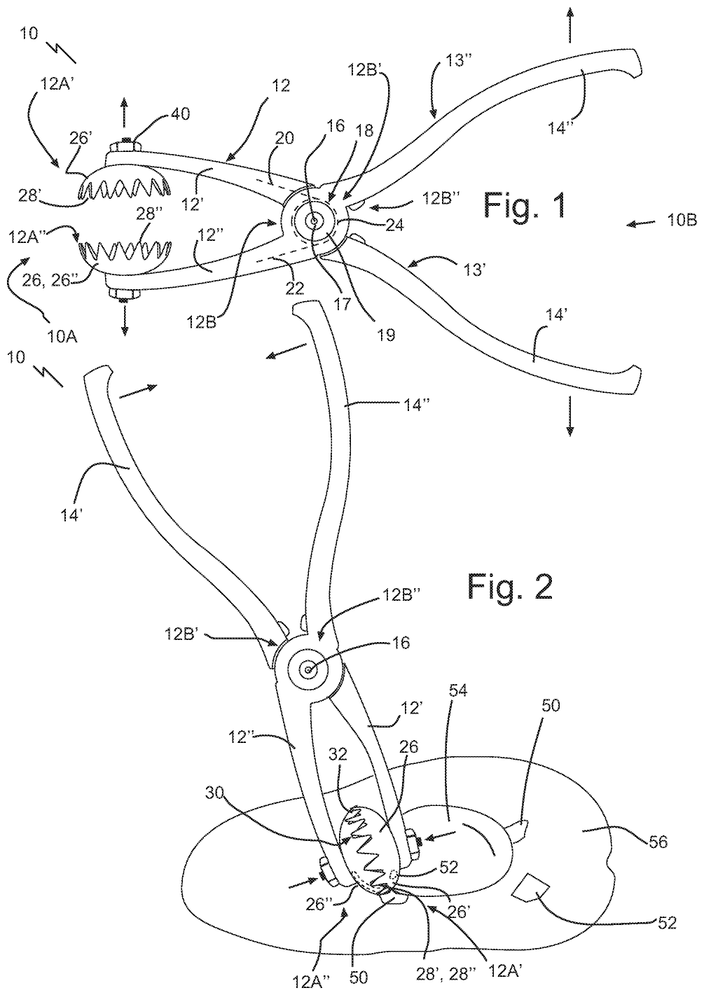

Referring to FIGS. 1 and 2, a kitchen utensil 10 is illustrated. Utensil 10 comprises jaws 12 connected to pivot relative to one another between an open position and a closed position. For example, the jaws 12 may be structured to pivot between an egg-part-receiving open position (FIG. 1) and an egg-part-holding closed position (FIG. 2). Each jaw 12 may have a respective grasping end 12A and a respective pivot end 12B. In the figures, references characters occasionally incorporate the suffix ′ or ″ to identify parts of a respective jaw or handle. Thus, it should be understood that when a reference character is used in this description to identify parts of the jaw or handle, such character may be found in the respective drawing with or without the suffix ′ or ″ added to the reference character. Referring to FIGS. 2 and 4, the grasping ends 12A may converge upon closure to define an egg-part-holding cavity 30 when the jaws 12 are in the closed position. One or both of the jaws 12 of the kitchen utensil 10 may incorporate teeth 28. In some cases teeth 28 are defined at respective grasping ends 12A of each jaw 12. In the closed position, the teeth 28 may mesh or interlock to define the egg-part-holding cavity 30. The cavity 30 may be enclosed when the jaws 12 are closed, for example to retain the chalaza and prevent or restrict the retained chalaza from falling out of the closed cavity 30 when the jaws 12 are closed.

Referring to FIGS. 1-4 an example of a method for using the kitchen utensil 10 is illustrated. Referring to FIGS. 1 and 2, the utensil 10 may be positioned adjacent to an egg yolk 54, egg white 56, or egg yolk 54 and egg white 56, with the jaws 12 in the open position. In the sequence shown from FIGS. 1 and 2, the utensil 10 may be operated by converging respective grasping ends 12A of jaws 12 together to close over and grasp an egg chalaza 50 or eggshell piece 52, adjacent to an egg yolk 54, egg white 56, or egg yolk 54 and egg white 56. The yolk 54 and white 56 and/or other internal parts of the egg become accessible by opening the egg, for example by cracking and removing the shell of the egg. Referring to FIG. 2, upon jaw closure, the part that is grasped by the jaws 12, for example the egg chalaza 50 or eggshell piece 52, may be retained, for example securely, within an egg-part-holding cavity 30 that is defined between the respective grasping ends 12A when the jaws 12 are closed as shown. Referring to FIG. 4, once the chalaza 50 or eggshell piece 52 is grasped and retained, the closed utensil 10 may be repositioned, for example over a garbage disposal 49 or other area suitable for disposing or storing or otherwise depositing the chalaza 50 or eggshell piece 52. The jaws 12 may be then opened to release the egg chalaza 50 or eggshell piece 52 from the egg-part-holding cavity 30.

Referring to FIG. 1, the kitchen utensil 10 may be formed by a plurality of levers. The kitchen utensil 10 may comprise a pair of levers 13. For example, FIG. 1 illustrates an embodiment where the utensil 10 takes the form of pliers, which are an example of a double class one lever, which have a scissor-like action. Each lever 13 may comprise a respective handle part 14 and a respective jaw 12. The levers may be pivotally connected, for example about a pivot axis 16. A first lever 13′ may be formed by a first jaw 12′ (the upper jaw in FIG. 1) and a first handle part 14′ (the lower handle in FIG. 1) and a second lever 13″ may be formed by a second jaw 12″ (the lower jaw in FIG. 1) and a second handle part 14′ (the upper handle in FIG. 1). Upper and lower are relative terms in this description and that do not refer to absolute orientations, since the tool or utensil 10 may be turned and used in any orientation. The handle parts 14 may define a user end 10B (opposite a grasping end 10A) for the user to grip and operate the kitchen utensil 10 with. The pivot axis 16 may be defined by a pivot pin 17, for example that mounts both levers 13. Other types of levers may be used, such as double class two or class three (example shown in FIG. 6) levers, include other lever systems, including more complicated lever systems than those shown such as where within each lever the respective handle part pivots or articulates relative to the respective jaw. The handle parts 14 may have a suitable structure, such as loops or hooks or high friction surfaces/pads to improve gripping by a user.

Referring to FIG. 2, the grasping ends 12A of the kitchen utensil 10 may define an enclosed egg-part-holding cavity 30 when the jaws 12 are in the closed position. Enclosed may refer to the fact that once in the closed position, the jaws 12 prevent the chalaza 50 or eggshell piece 52 from exiting the cavity 30, to securely retain the chalaza 50 or eggshell piece 52 within cavity 30. For example, when enclosed the chalaza 50 or eggshell piece 52 may be blocked from exiting cavity 30 out a front 34, sides 36 and a rear 38, of a jaw-to-jaw interface 32 defined by the jaws 12′ and 12″ when closed. The front 34 may be considered to be the part of the jaw-to-jaw interface 32 that is furthest from the pivot axis 16 of the kitchen utensil 10, with the rear 38 being the closest and the sides 36 defined in opposition to one another and in between the rear 38 and front 34. Blocking may be achieved by the structuring of the grasping ends 12A such that when the jaws are closed no openings to cavity 30 with a maximum dimension of three millimeters or more are present for the chalaza 50 or eggshell piece 52 to exit cavity 30 out of Range of bite may be limited to define gaps between adjacent teeth upon closure, for example to provide a gentler bite upon closure, than if the teeth meshed without gaps, so that the yoke remains unaffected upon bite. The formation of gaps or holes between the teeth allow for the gentle action of the egg white and chalaza to separate without affecting the breaking of the yoke. The combined action of the teeth and gaps may allow for a clean removal of the majority of chalaza within seconds. The gaps may be small enough to keep the existing chalaza in the pocket storage chamber (cavity 30) 365 degrees, yet the chalaza will not fall out until the device is opened/released. If the device remains closed, the gaps may provide the device to air dry to prevent moisture from being trapped inside the pocket chamber. The jaws jaw-to-jaw interface 32 may completely encircle the egg-part-holding cavity 30 to form an enclosed receptacle, for example for retaining an egg chalaza. Encircling may refer to there being jaw to jaw contact or near-contact about a perimeter of the cavity 30.

Referring to FIG. 2, the kitchen utensil 10 may incorporate teeth 28, for example for one or both of grasping and severing an egg chalaza 50 or eggshell piece 52. Teeth 28 may penetrate and pierce the chalaza 50, or teeth 28 may grasp and hold the chalaza 50, or teeth 28 may overbite the chalaza 50 to completely swallow the chalaza 50 and sever and tear the tissue surrounding the chalaza 50 to permit the chalaza 50 to be completely retained within the cavity 30. Teeth 28 may be positioned at one or both respective grasping ends 12A.

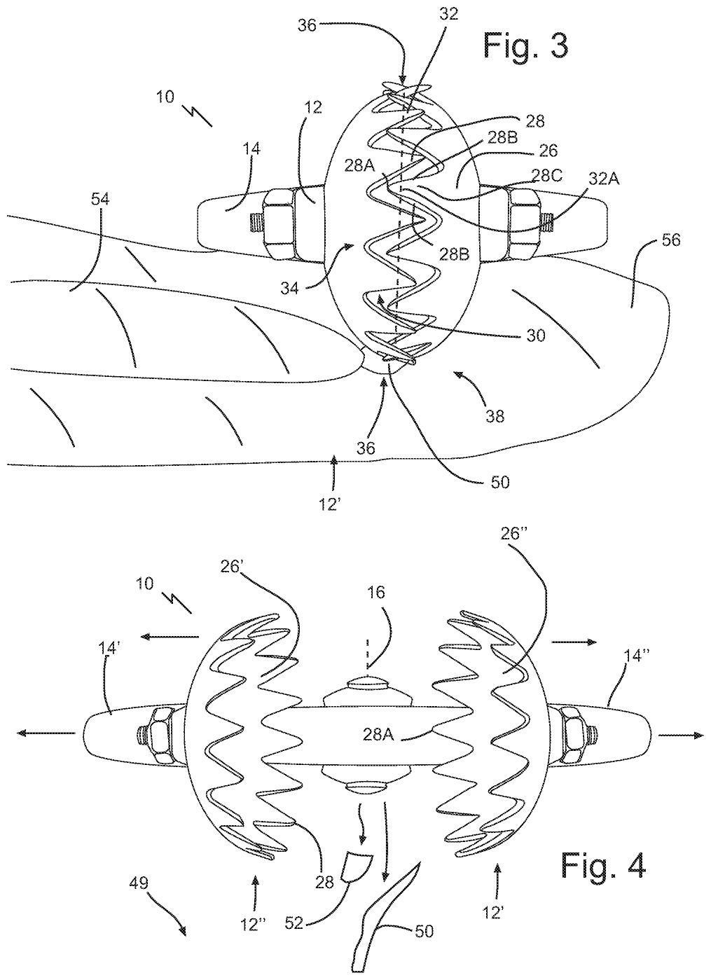

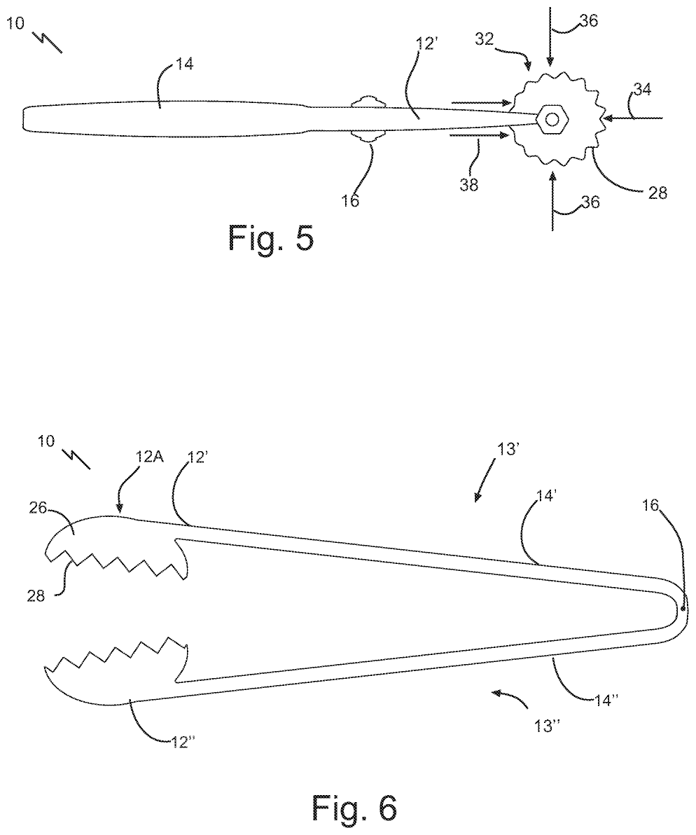

Teeth 28 may be arranged to mesh together, for example at suitable locations along a jaw-to-jaw interface 32 defined around the egg-part-holding cavity 30, when the jaws 12 are in the egg-part-holding closed position. For example, referring to FIGS. 3 and 5, the teeth 28 may be positioned to mesh at one or more of the front 34, sides 36, or at or near the rear 38 of the jaw-to-jaw interface 32. For example, the teeth 28 may be distributed along the respective grasping ends 12A to mesh continuously about the jaw-to-jaw interface 32 to substantially or fully encircle the egg-part-holding cavity 30, for example to allow a user to grasp the egg chalaza 50 or eggshell piece 52 from any of the front 34, sides 36, or the rear 38 of the jaw-to-jaw interface 32. Teeth may also be distributed to continuously mesh about the jaw-to-jaw interface 32 to enclose the egg-part-holding cavity when the jaws 12 are in the closed position. Referring to FIG. 5, by positioning the teeth 28 at least partially and in some cases fully around the periphery of the cavity 30, the utensil 10 may approach the item to be grasped from numerous and in some cases any direction relative to the interface 32, providing flexibility to the user as to angle of approach relative to the item. In the case shown, the chalaza 50 (not shown) may be picked up from the front 34, sides, 36, or rear 38. Referring to FIGS. 2 and 3, examples are shown where the chalaza 50 is grasped from the front 34 (FIG. 2) and side 36 (FIG. 3) of the grasping end 12A.

Referring to FIG. 3, the kitchen utensil 10 may incorporate teeth 28 that protrude. For example, teeth 28 may be configured to project outwards relative to cavity 30 such that the teeth 28 may at least partially cross-over when viewed along a contact plane 32A defined by the interface 32 when the jaws 12 are in the closed position. The kitchen utensil 10 may for example, incorporate teeth 28 that protrude, allowing the teeth 28 to point in different directions relative to each other to improve the grasp upon the egg chalaza 50. Protruding teeth may also be incorporated to increase the surface area of the contact between the egg chalaza 50 and the jaws 12, for example to provide a more secure grip. In some cases, teeth that project inward, or outward and inward, may be used. A protruding orientation is one example of a mechanism that may improve gripping while reducing piercing of the chalaza 50, to ensure that a chalaza 50 that is gripped part way along its length will not be severed, leaving part of the chalaza 50 with the egg.

Referring to FIGS. 1-6, the kitchen utensil 10 may incorporate teeth 28 that are structured to one or more of improve grasping and piercing of an item such as chalaza 50. Referring to FIG. 3, in the example shown the teeth 28 may be pointed, which may mean that each tooth has a terminal tip 28A that represents an apex of a surface or a plurality of adjacent surfaces such as formed by edges 28B and planar faces 28C of each tooth. The teeth 28 may have a suitable shape, such as by being planar or conical or conical and planar. In some cases, the teeth 28 may be blunt, or incorporate both blunt and pointed features. The teeth 28 may be triangular in shape, for example as shown where edges 28B form a triangular shape. Surfaces, such as edges 28B, of the teeth 28 may be serrated (not shown), for example to increase points of contact between meshing teeth 28 to more effectively grip or sever an egg-part from the egg yolk 54, or egg white 56. The teeth 28 may also be barbed, for example where a hooking mechanism is desired. Other suitable shapes and structures of teeth 28 may be used. Increasing contact surface area and penetrating action of teeth 28 acts to increase friction and counteract the tendency of internal parts of the egg resist grasping. In some cases one or more jaws 12 may define a blade edge that is structured to cut the chalaza 50.

Referring to FIGS. 1, 2, and 4 one or both jaws 12 may be structured to contain the item to be grasped, such as the chalaza 50. For example, one or both jaws 12 may comprise cupping members 26. First jaw 12′ may define a first cupping member 26′ at the respective grasping end 12A, in which the first cupping member 26′ at least partially defines the egg-part-holding cavity 30 when the jaws 12 are in the closed position. The second jaw 12″ may define a second cupping member 26″ at the respective grasping end 12A, in which the first cupping member 26′ and the second cupping member 26″ collectively define the egg-part-holding cavity 30 when the jaws are in the closed position. The cupping members 26 may be shaped to cup the egg-part when in the closed position to form the egg-part-holding cavity. A cupping member may form a bowl that defines a receptacle to contain a liquid. A cupping member may have a semi-spherical shape, or other rounded or non-rounded shape. Providing cupping members that enclose the cavity 30 prevent the chalaza 50 or other egg part from falling out the sides or rear of the cavity 30 while moving the utensil 10, for example while transporting the closed utensil 10 to over a disposal area where the jaws 12 may be opened and the interior contents of the cavity 30 discarded.

Referring to FIG. 1, the kitchen utensil 10 may be biased into an open or closed position. In the example shown the jaws 12 are biased into the egg-part-receiving open position, as shown with arrows. In one case the biasing is accomplished using a spring, such as a torsion spring 18, which may be mounted in a suitable fashion such as internally within jaws 12. In the example shown, the kitchen utensil 10 is biased open, so that a user (not shown) must apply constant pressure inward against handle parts 14 to converge the jaws 12 against the biasing force in order to move the kitchen utensil 10 into the closed position shown in FIG. 2. Referring to FIG. 4, on releasing inward clenching or squeezing pressure against the handle parts 14, the jaws 12 diverge to open, allowing the egg-part to be released from the egg-part-holding cavity 30. In other embodiments, the kitchen utensil 10 may be biased into the closed position. Referring to FIG. 1 the torsion spring 18 may have a suitable structure such as an intermediate spiral section 24, which may substantially, for example fully, encircles the pivot pin 17, and a first arm 20 and second arm 22 that extend into or along the first jaw 12′ and second jaw 12″, respectively. A washer 19 may be present. Pin 17 may form a rivet or other suitable axle part.

Referring to FIG. 6, another embodiment of a kitchen utensil 10 is illustrated. The example shown provides levers 13 as class three double levers. Thus, handle parts 14 are located in between pivot axis 16 and jaws 12, such that during use a user applies one or both of inward and outward force against handle parts 14 to close or open, respectively, the jaws 12. One or more of the parts of the levers 13, for example the handle parts 14, may be made of resilient material to accommodate the flexing of the levers 13. In the example shown the levers 13 are integrally connected to form a living hinge, such as would be provided by a molded plastic utensil 10. In other cases, levers 13 may be formed of discrete parts that are connected together, for example via a pivot pin 17 (not shown).

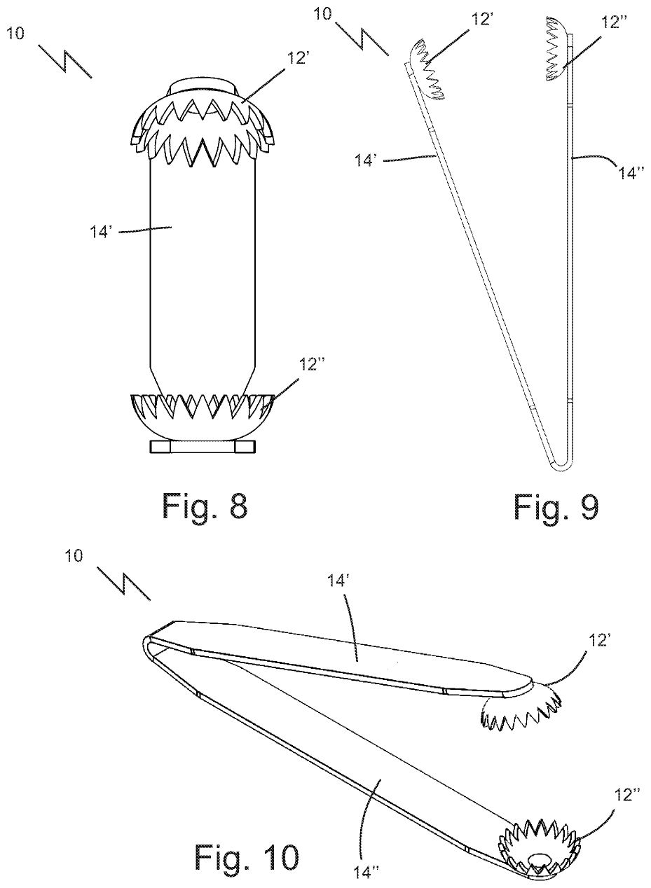

Referring to FIGS. 8-11, a further variant of the kitchen utensil 10 embodiment of FIG. 6 is illustrated. In the example shown the jaws 12′ and 12″ (cups) may be connected to the handle parts 14′ and 14″ by a suitable connection, such as a weld connection, although other connections may be used such as adhesive or riveting/fasteners. Each jaw 12 and in some cases the handle parts 14 may be formed by laser cutting the requisite shape out of a blank of metal, followed by bending of the teeth in the jaws and bending of the handle parts to create the shape shown. Other forms of assembly and manufacture may be used.

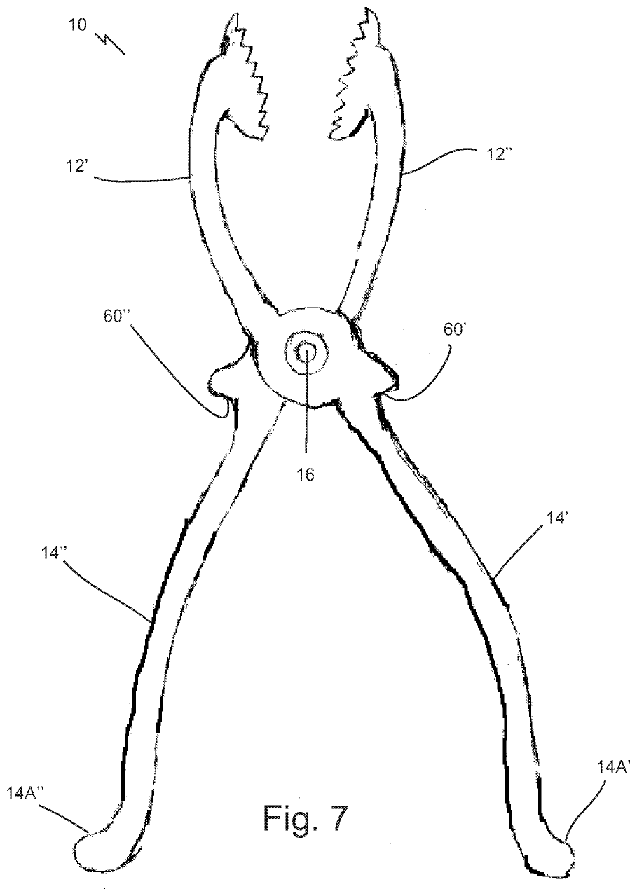

Referring to FIG. 7, a further embodiment of utensil 10 is illustrated. Each handle part 14 may incorporate fingertip stop detents 60 facing the handle part 14 to provide a surface contoured to ergonomically receive a fingertip, such as a thumb tip, during operation of the handle parts 14. Detents 60 may be located at or near a pivot end of the handle parts 14. Palm stop detents 14A may be located on handle parts 14, for example at or near user ends of the handle parts 14 as shown, for example to provide a surface contoured to ergonomically receive a palm of a user's hand during operation of the handle parts 14.

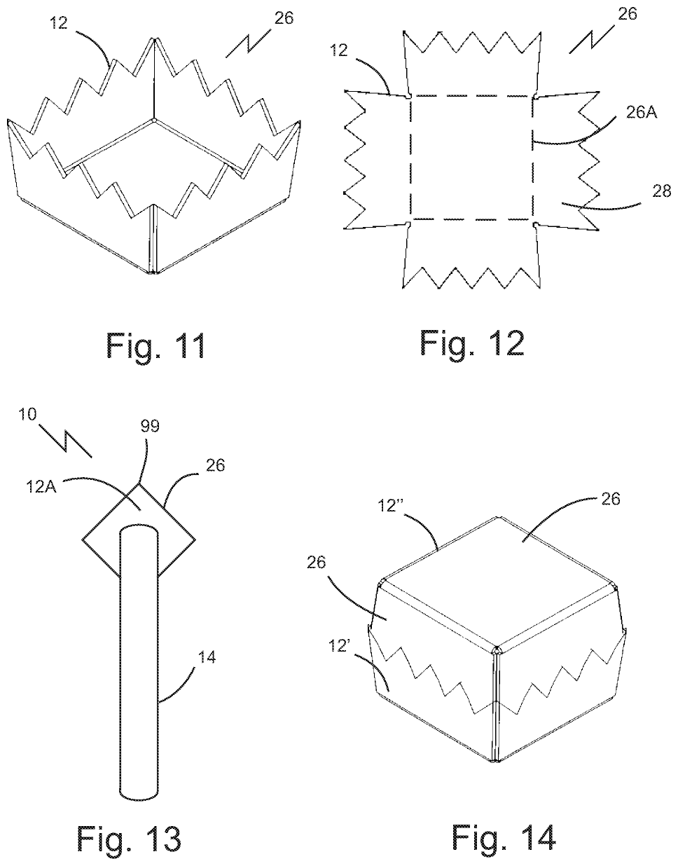

Referring to FIGS. 11-14 a further embodiment of a kitchen utensil 10 is illustrated, having a diamond or rectangular box shaped grasping end/cupping members. Referring to FIGS. 11 and 12, each jaw 12′, 12″ may be formed from a blank of metal that is bent at lines 26A to form the requisite shape shown in FIG. 11. Referring to FIG. 13, the jaws 12 may be oriented in a suitable fashion, such as with a vertex 99 of the rectangular box pointing axially forward at grasping end 12A as shown, or in another orientation such as a flat side of the box pointing axially forward (not shown).

Utensil 10 may be used for tasks other than grasping and retaining egg parts. For example, utensil 10 may be used to remove hot peppers from a stir fry. In other cases the jaws 12 may be structured to fit larger items such as an egg yolk.

The utensil 10 may be made from suitable materials. For example, moulded zinc, steel, or other forms of metal components may be used. In some cases polymeric components may be used, such as plastic. Materials that can withstand the relatively high heat of a frying pan may be used, as may other materials.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A kitchen utensil comprising jaws connected to pivot relative to one another between an egg-part-receiving open position and an egg-part-holding closed position, such that teeth defined at respective grasping ends of each jaw converge upon closure to mesh and define an enclosed egg-part-holding cavity when the jaws are in the egg-part-holding closed position.

2. The kitchen utensil of claim 1 in which the teeth protrude outwardly relative to the egg-part-holding-cavity when the jaws are in the egg-part-holding closed position.

3. The kitchen utensil of claim 1 formed as a pair of pliers.

4. The kitchen utensil of claim 1 structured such that the egg-part-holding cavity is enclosed when the jaws are in the egg-part-holding closed position.

5. The kitchen utensil of claim 1 in which the teeth are positioned at each respective grasping end to mesh together at a front, sides, and a rear, of a jaw-to-jaw interface defined around the egg-part-holding cavity when the jaws are in the egg-part-holding closed position.

6. The kitchen utensil of claim 5 in which the teeth are distributed to mesh continuously about the jaw-to-jaw interface to substantially encircle the egg-part-holding cavity.

7. The kitchen utensil of claim 1 in which a first jaw of the jaws defines a first cupping member at the respective grasping end, in which the first cupping member at least partially defines the egg-part-holding cavity when the jaws are in the egg-part-holding closed position.

8. The kitchen utensil of claim 7 in which a second jaw of the jaws defines a second cupping member at the respective grasping end, in which the first cupping member and the second cupping member collectively define the egg-part-holding cavity when the jaws are in the egg-part-holding closed position.

9. The kitchen utensil of claim 1 in which the teeth are pointed.

10. The kitchen utensil of claim 9 in which the teeth are triangular in shape.

11. The kitchen utensil of claim 1 in which the jaws are biased into the egg-part-receiving open position.

12. The kitchen utensil of claim 11 further comprising a torsion spring mounted between the jaws to bias the jaws into the egg-part-receiving open position.

13. The kitchen utensil of claim 1 comprising an egg chalaza or eggshell piece held securely within the egg-part-holding cavity.

14. A method comprising converging respective grasping ends of jaws of a kitchen utensil together to close and grasp an egg chalaza or eggshell piece, adjacent to or forming part of an egg, and to retain the egg chalaza or eggshell piece within an enclosed egg-part-holding cavity that is defined between the respective grasping ends when the jaws are closed.

15. The method of claim 14 in which the egg chalaza or eggshell piece is grasped by teeth defined at the respective grasping ends of each jaw.

16. The method of claim 15 in which the teeth are configured to mesh and define the enclosed egg-part-holding cavity when the jaws are closed.

17. The method of claim 16 in which the teeth mesh together and grasp the egg chalaza or eggshell piece at sides of a jaw-to-jaw interface defined around the enclosed egg-part-holding cavity when the jaws are closed, in which the sides are defined relative to a front of the jaw-to-jaw interface adjacent the respective grasping ends.

18. The method of claim 17 in which the teeth mesh together and grasp the egg chalaza or eggshell piece at or near a rear of a jaw-to-jaw interface, which is defined around the enclosed egg-part-holding cavity when the jaws are closed, in which the rear is defined relative to a front of the jaw-to-jaw interface adjacent the respective grasping ends.

19. The method of claim 14 in which the enclosed egg-part-holding cavity is defined by respective cupping members at the respective grasping ends of the jaws.

20. The method of claim 14 further comprising opening the jaws to release the egg chalaza or eggshell piece from the enclosed egg-part-holding cavity.
